(19) United States
(12) Patent Application Publication
(10) Pub. No.: US 2022/0106669 A1
(43) Pub. Date: Apr. 7, 2022

(54) COPPER ALLOY MATERIAL

(71) Applicant: MITSUBISHI MATERIALS CORPORATION, Tokyo (JP)

(72) Inventors: Satoshi Kumagai, Sakai-shi (JP); Yoshiyuki Akiyama, Iwaki-shi (JP); Norikazu Ishida, Tokyo (JP)

(73) Assignee: MITSUBISHI MATERIALS CORPORATION, Tokyo (JP)

(21) Appl. No.: 17/421,074

(22) PCT Filed: Jan. 10, 2020
(86) PCT No.: PCT/JP2020/000730

§ 371 Date: Jul. 7, 2021

(30) Foreign Application Priority Data
Jan. 11, 2019 (JP) 2019-003371

(51) Int. Cl. C22C 9/00; C22F 1/08; H01B 1/02

(52) U.S. Cl. CPC C22C 9/00; H01B 1/026; C22F 1/08

(57) ABSTRACT

A copper alloy material having a composition contains, Mg in a range of 0.15 mass % or more and 0.50 mass % or less, Cr in a range of 0.20 mass % or more and 0.90 mass % or less, and a balance consisting of Cu and inevitable impurities. Tensile strength is 600 MPa or more, and elongation is 3% or more. Electric conductivity is preferably 60% TACS or more.

### TECHNICAL FIELD

The present invention relates to, for example, a copper alloy material used for wiring of vehicles and equipment, wires for robots, wires for airplanes, and the like.

Priority is claimed on Japanese Patent Application No. 2019-003371, filed Jan. 11, 2019, the content of which is incorporated herein by reference.

### BACKGROUND ART

As electric wires for vehicle wiring and electric wires for equipment wiring, products in which an electric wire conductor prepared by twisting a plurality of copper wires is coated with an insulating film have been provided. In order to efficiently prepare wiring and the like, a wire harness in which a plurality of the electric wires are bundled is provided.

In recent years, from the viewpoint of environmental protection, there has been a strong demand for weight reduction of a vehicle body to reduce the amount of carbon dioxide emitted from a vehicle. Meanwhile, the electrification of vehicles is progressing, and the development of hybrid cars and electric cars is also progressing. The number of components of an electric system used in a vehicle is acceleratingly increasing. Accordingly, the amount of usage of the wire harness connecting the components is expected to further increase in the future, and weight reduction of the wire harness is required.

As means for reducing the weight of the wire harness, the cross-sectional area of electric wires and copper wires is reduced. By reducing the cross-sectional area of the electric wire conductor and the copper wire, the wire harness can be reduced in weight and size, and there is an advantage in that the wiring space can be effectively utilized.

As the above-described copper wire, a copper wire formed of a pure copper material such as tough pitch copper has been primarily used, and a soft copper wire heat-treated at a high temperature is used to absorb the impact due to vibration during assembling of the wire harness or after vehicle mounting. Since the pure copper material has a high elongation, it has excellent handleability.

However, the pure copper material is extremely weak against a tensile load applied instantaneously, easily exceeds the elastic deformation region, and reaches the plastic deformation region. In a case where a higher load is applied thereto, the pure copper material breaks. That is, a copper wire made of the pure copper material has a sufficient elongation, and its strength is not sufficient.

Since the copper wire made of the pure copper material does not secure sufficient strength, it has not been possible to achieve the weight reduction and size reduction by a reduction in the cross-sectional area.

Accordingly, as a copper wire having an improved strength, for example, Patent Documents 1 and 2 propose a copper alloy wire made of a Cu—Sn alloy containing Sn. Patent Document 3 proposes a copper alloy wire made of a Cu—Mg alloy containing Mg.

The Cu—Sn alloy and the Cu—Mg alloy described above are solid solution strengthening type copper alloys in which the strength is improved by solid solution in copper, and these have sufficiently improved strength as compared with the above-described pure copper material.

Patent Documents 4 to 6 propose a copper alloy wire made of a Cu—Co—P alloy containing Co and P. In addition, Patent Documents 7 and 8 propose a copper alloy wire made of a Cu—Ni—Si alloy containing Ni and Si.

The Cu—Co—P alloy and the Cu—Ni—Si alloy are precipitation strengthening type copper alloys in which the strength is improved by dispersing precipitates in a parent phase of copper, and these have sufficiently improved strength as compared with the above-described pure copper material.

### CITATION LIST

### Patent Literature

### [Patent Document 1]

Japanese Unexamined Patent Application, First Publication No. 2008-027640

### [Patent Document 2]

Japanese Patent No. 2709178

### [Patent Document 3]

Japanese Unexamined Patent Application, First Publication No. 2009-174038

### [Patent Document 4]

Japanese Unexamined Patent Application, First Publication No. 2010-212164

### [Patent Document 5]

Japanese Unexamined Patent Application, First Publication No. 2014-025137

### [Patent Document 6]

Japanese Unexamined Patent Application, First Publication No. 2015-004126

### [Patent Document 7]

Japanese Unexamined Patent Application, First Publication No. 2008-266764

### [Patent Document 8]

Japanese Unexamined Patent Application, First Publication No. 2009-091627

### SUMMARY OF INVENTION

### Technical Problem

The solid solution strengthening type copper alloys such as a Cu—Sn alloy and a Cu—Mg alloy have high strength, but do not have sufficient elongation in a state of being molded by cold working, and these were difficult to handle since wire spattering or wire entanglement was likely to occur during assembling of a wire harness. As a method of enhancing the elongation of the solid solution strengthening type copper alloy, it is considered that a heat treatment is performed to recover the structure. However, in a case where the heat treatment temperature reaches the softening point, the tensile strength and the elongation rapidly change in the solid solution strengthening type copper alloy. Whereby, it was very difficult to control the heat treatment conditions, and thus it was difficult to accurately control the tensile strength and the elongation. Accordingly, even in a case where the solid solution strengthening type copper alloy such as a Cu—Sn alloy and a Cu—Mg alloy is used, both elongation and strength cannot be achieved, and it is not possible to reduce the cross-sectional area of a copper alloy wire.

In the case of the precipitation strengthening type alloys such as a Cu—Co—P alloy and a Cu—Ni—Si alloy, the temperature range during a heat treatment is wide, and thus control is relatively easily performed, and it is possible to improve a spring property and an elongation. However, it was not possible to obtain sufficient strength only by precipitation strengthening, and it was not possible to reduce the cross-sectional area of a copper alloy wire.

The present invention is contrived with the above circumstances as a background, and an object of the present invention is to provide a copper alloy material which is sufficiently excellent in strength and elongation and can be handled well even in a case where a cross-sectional area is reduced.

### Solution to Problem

In order to solve the problems, according to the present invention, a copper alloy material having a composition comprising: Mg in a range of 0.15 mass % or more and 0.50 mass % or less; Cr in a range of 0.20 mass % or more and 0.90 mass % or less; and a balance consisting of Cu and inevitable impurities, in which tensile strength is 600 MPa or more, and elongation is 3% or more.

Since the copper alloy material having the above configuration contains Mg in the above-described range, the strength can be sufficiently improved by solid solution hardening. Furthermore, since Cr is contained in the above-described range, the temperature range during the heat treatment for dispersing the Cr-based precipitates is wide, and thus control is relatively easily performed, and it is possible to stably improve the strength and the elongation.

In addition, the tensile strength is 600 MPa or more, and the elongation is 3% or more. Accordingly, even in a case where the copper alloy material has a small cross-sectional area, it is possible to suppress the occurrence of disconnection or the like during handling, and easy handling is possible.

In the copper alloy material of the present invention, electric conductivity is preferably 60% IACS or more.

In this case, since the electric conductivity is 60% IACS or more, the Cr-based precipitates are sufficiently precipitated and dispersed, and the strength and elongation can be sufficiently improved.

Furthermore, due to excellent conductive property (heat conductive property), the copper alloy material is particularly suitable as a material for a conductive member, a heat transfer member, or the like.

In the copper alloy material of the present invention, the copper alloy material may be provided as a wire material, and a cross-sectional area perpendicular to a longitudinal direction may be in a range of 0.0003 mm² or more and 0.2 mm² or less.

In this case, since the wire material is excellent in strength and elongation, the wire material can be easily handled even in a case where the cross-sectional area is reduced.

In addition, since the cross-sectional area perpendicular to the longitudinal direction is in a range of 0.0003 mm² or more and 0.2 mm² or less, it is possible to reduce the size and weight of various components such as wire harnesses using the copper alloy wire.

### Advantageous Effects of Invention

According to the present invention, it is possible to provide a copper alloy material which is sufficiently excellent in strength and elongation and can be handled well even in a case where a cross-sectional area is reduced.

### BRIEF DESCRIPTION OF DRAWINGS

FIG. 1 is a flowchart showing a method of producing a copper alloy material according to an embodiment of the present invention.

### DESCRIPTION OF EMBODIMENTS

Hereinafter, a copper alloy material according to an embodiment of the present invention will be described.

A copper alloy material according to this embodiment is used as, for example, a wire of an insulated wire constituting a wire harness which is used for wiring of a vehicle or the like.

The copper alloy material according to this embodiment has a shape corresponding to a working method during component molding, and constitutes, for example, a plate strip material, a wire rod material, or a tubular material. In this embodiment, the copper alloy material is provided as a wire material.

A composition of the copper alloy material according to this embodiment contains Mg in a range of 0.15 mass % or more and 0.50 mass % or less, Cr in a range of 0.20 mass % or more and 0.90 mass % or less, and the balance consisting of Cu and inevitable impurities.

In the copper alloy material according to this embodiment, the tensile strength is 600 MPa or more, and the elongation is 3% or more.

The copper alloy material according to this embodiment preferably has electric conductivity of 60% IACS or more.

In the copper alloy material according to this embodiment, a cross-sectional area perpendicular to a longitudinal direction is preferably in a range of 0.0003 mm² or more and 0.2 mm² or less.

The reasons why the component composition, the various characteristics, and the cross-sectional area of the copper alloy material according to this embodiment are regulated as described above will be described below.

### (Mg: 0.15 Mass % or More and 0.50 Mass % or Less)

Mg is an element which acts to sufficiently improve strength by being solid-dissolved in a parent phase of a copper alloy.

In a case where the Mg content is less than 0.15 mass %, the action and effect may not be sufficiently exhibited. In contrast, in a case where the Mg content is more than 0.50 mass %, the electric conductivity may be significantly reduced, the viscosity of the molten copper alloy may be increased, and the castability may be reduced. In addition, a coarse Mg compound may be generated, and defects such as cracks may occur during working.

From the above, in this embodiment, the Mg content is set in a range of 0.15 mass % or more and 0.50 mass % or less.

In order to further improve the strength, the lower limit of the Mg content is preferably 0.16 mass % or more, and more preferably 0.17 mass % or more. In order to securely suppress a reduction in the electric conductivity, castability, and workability, the upper limit of the Mg content is preferably 0.48 mass % or less, and more preferably 0.46 mass % or less.

### (Cr: 0.20 Mass % or More and 0.90 Mass % or Less)

Cr is an element which has an effect on improvement of strength and electric conductivity as well as elongation by precipitating fine Cr-based precipitates (for example, Cu—Cr) in crystal grains of the parent phase by an aging treatment.

In a case where the Cr content is less than 0.20 mass %, the precipitation amount is not sufficient in the aging treatment, and the improvement of the strength, electric conductivity, and elongation may not be sufficiently achieved. In addition, in a case where the Cr content is more than 0.90 mass %, relatively coarse Cr crystallized products may be generated, which may cause defects.

From the above, in this embodiment, the Cr content is set in a range of 0.20 mass % or more and 0.90 mass % or less.

In order to securely exhibit the above-described action and effect, the lower limit of the Cr content is preferably 0.22 mass % or more, and more preferably 0.24 mass % or more. In order to further suppress the generation of relatively coarse Cr crystallized products and further suppress the occurrence of defects, the upper limit of the Cr content is preferably 0.85 mass % or less, and more preferably 0.80 mass % or less.

### (Other Inevitable Impurities)

Examples of inevitable impurities other than Mg and Cr described above include Al, Fe, Ni, Zn, Mn, Co, Ti, B, Ag, Ca, Si, Te, Sr, Ba, Sc, Y, Ti, Zr, Hf, V, Nb, Ta, Mo, W, Re, Ru, Os, Se, Rh, Ir, Pd, Pt, Au, Cd, Ga, In, Li, Ge, As, Sb, Tl, Pb, Be, N, H, Hg, Tc, Na, K, Rb, Cs, Po, Bi, lanthanoid, O, S, C, and P. Since the inevitable impurities may reduce conductive property (heat conductive property), the total amount thereof is preferably 0.05 mass % or less.

### (Tensile Strength: 600 MPa or More)

In the copper alloy material according to this embodiment, in a case where the tensile strength is less than 600 MPa, the strength is not sufficient, and breakage may occur during handling. In particular, the strength is likely to be insufficient in a case where the copper alloy material is used after a reduction in the cross-sectional area.

Accordingly, in the copper alloy material according to this embodiment, the tensile strength is set to 600 MPa or more.

The tensile strength of the copper alloy material according to this embodiment is preferably 620 MPa or more, and more preferably 640 MPa or more. The upper limit of the tensile strength of the copper alloy material according to this embodiment is not particularly limited, but is practically 1,200 MPa or less.

### (Elongation: 3% or More)

In the copper alloy material according to this embodiment, in a case where the elongation is less than 3%, the elongation is not sufficient, and spattering or entanglement may occur during handling. Accordingly, it is difficult to assemble a wire harness or the like.

Therefore, in the copper alloy material according to this embodiment, the elongation is set to 3% or more.

The elongation of the copper alloy material according to this embodiment is preferably 4% or more, and more preferably 5% or more. The upper limit of the elongation of the copper alloy material according to this embodiment is not particularly limited, but is practically 30% or less.

### (Electric Conductivity: 60% IACS or More)

In the copper alloy material according to this embodiment, in a case where the electric conductivity is 60% IACS or more, the Cr-based precipitates are sufficiently dispersed. Accordingly, the copper alloy material is excellent in strength, elongation, and conductive property (heat conductive property).

From the above, in the copper alloy material according to this embodiment, the electric conductivity is preferably 60% IACS or more.

The electric conductivity of the copper alloy material according to this embodiment is more preferably 62% IACS or more, and even more preferably 64% IACS or more. The upper limit of the electric conductivity of the copper alloy material according to this embodiment is not particularly limited, but is practically 90% IACS or less.

(Cross-Sectional Area Perpendicular to Longitudinal Direction: 0.0003 mm² or More and 0.2 mm² or Less)

The copper alloy material according to this embodiment constitutes a wire material. In a case where a cross-sectional area of the wire material perpendicular to a longitudinal direction is 0.0003 mm² or more, the strength of the copper alloy material is secured, and thus it is possible to sufficiently suppress the occurrence of disconnection during handling. In a case where the cross-sectional area perpendicular to the longitudinal direction is 0.2 mm² or less, the cross-sectional area is sufficiently reduced, and various components made of the copper alloy member can be further reduced in size and weight.

From the above, in the copper alloy material according to this embodiment, the cross-sectional area perpendicular to the longitudinal direction is preferably in a range of 0.0003 mm² or more and 0.2 mm² or less.

The lower limit of the cross-sectional area perpendicular to the longitudinal direction of the copper alloy material according to this embodiment is more preferably 0.001 mm² or more, and even more preferably 0.005 mm² or more. The upper limit of the cross-sectional area perpendicular to the longitudinal direction is more preferably 0.16 mm² or less, and even more preferably 0.13 mm² or less.

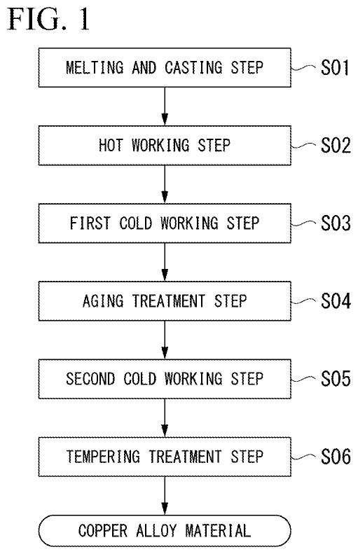

Next, a method of producing the copper alloy material according to an embodiment of the present invention will be described with reference to the flowchart of FIG. 1.

### (Melting and Casting Step S01)

First, a copper raw material formed of oxygen-free copper having a copper purity of 99.99 mass % or more is put into a carbon crucible and melted using a vacuum melting furnace to obtain molten copper. Next, Mg and Cr are added to the obtained molten metal so as to obtain a predetermined concentration, and thus the components are adjusted and a molten copper alloy is obtained.

Regarding raw materials of Mg and Cr, for example, a material having a purity of 99.9 mass % or more is preferably used as the raw material of Mg, and a material having a purity of 99.9 mass % or more is preferably used as the raw material of Cr. A Cu-Mg mother alloy or a Cu—Cr mother alloy may be used.

The molten copper alloy whose components have been adjusted is poured into a mold to obtain a copper alloy ingot.

### (Hot Working Step S02)

Next, the copper alloy ingot is subjected to hot working. Preferable conditions for the hot working are as follows: temperature: 600° C. or higher and 1,050° C. or lower, working rate: 50% or more and 99.5% or less. After the hot working, the ingot is immediately cooled by water cooling.

The working method in the hot working step S02 is not particularly limited, but in a case where the final shape is a plate or a strip, rolling may be applied. In a case where the final shape is a line or a rod, extrusion or groove rolling may be applied. In a case where the final shape is a bulk shape, forging or pressing may be applied.

### (First Cold Working Step S03)

Next, the hot worked material which has undergone the hot working step S02 is subjected to cold working. In the first cold working step S03, the working rate is preferably in a range of 50% or more and 99.5% or less.

The working method in the first cold working step S03 is not particularly limited, but in a case where the final shape is a plate or a strip, rolling may be applied. In a case where the final shape is a line or a rod, extrusion or groove rolling may be applied. In a case where the final shape is a bulk shape, forging or pressing may be applied.

### (Aging Treatment Step S04)

Next, the cold worked material obtained in the first cold working step S03 is subjected to an aging treatment to precipitate fine precipitates such as Cr-based precipitates.

Preferable conditions for the aging treatment are as follows: holding temperature: 350° C. or higher and 550° C. or lower, holding time at holding temperature: 0.5 hours or longer and 6 hours or shorter.

The heat treatment method during the aging treatment is not particularly limited, but the treatment is preferably performed in an inert gas atmosphere. The cooling method after the heating is not particularly limited, but water cooling is preferably performed for rapid cooling.

### (Second Cold Working Step S05)

Next, the aging-treated material which has undergone the aging treatment step S04 is subjected to cold working. In the second cold working step S05, the working rate is preferably in a range of 90% or more and 99.99% or less.

The working method in the second cold working step S05 is not particularly limited, but in a case where the final shape is a plate or a strip, rolling may be applied. In a case where the final shape is a line or a rod, extrusion or groove rolling may be applied. In a case where the final shape is a bulk shape, forging or pressing may be applied.

In this embodiment, due to the second cold working step S05, the cross-sectional area perpendicular to the longitudinal direction is in a range of 0.0003 mm² or more and 0.2 mm² or less.

### (Tempering Treatment Step S06)

Next, the cold worked material obtained in the second cold working step S05 is subjected to a tempering treatment to improve its elongation.

Preferable conditions for the tempering treatment are as follows: holding temperature: 350° C. or higher and 550° C. or lower, holding time at holding temperature: 0.5 hours or longer and 6 hours or shorter.

The method for the tempering treatment is not particularly limited, but the treatment is preferably performed in an inert gas atmosphere. The cooling method after the heating is not particularly limited, but water cooling is preferably performed for rapid cooling.

By the above steps, the copper alloy material according to this embodiment is produced.

According to the copper alloy material according to this embodiment having the above-described configuration, Mg is contained in a range of 0.15 mass % or more and 0.50 mass % or less, and thus the strength can be sufficiently improved by solid solution hardening.

Furthermore, since Cr is contained in a range of 0.20 mass % or more and 0.90 mass % or less, the temperature range during the heat treatment for dispersing the Cr-based precipitates is wide, and thus control is relatively easily performed, and it is possible to improve the strength and the elongation.

In addition, the copper alloy material according to this embodiment has tensile strength of 600 MPa or more and elongation of 3% or more. Accordingly, even in a case where the copper alloy material has a small cross-sectional area, it is possible to suppress the occurrence of disconnection or the like during handling, and stable handling is possible.

In this embodiment, since the electric conductivity is 60% IACS or more, the Cr-based precipitates are sufficiently precipitated and dispersed, and it is possible to sufficiently improve the strength and the elongation. In addition, the copper alloy material is particularly suitable for use requiring conductive property (heat conductive property).

In this embodiment, the copper alloy material is provided as a wire material, and a cross-sectional area perpendicular to a longitudinal direction is in a range of 0.0003 mm² or more and 0.2 mm² or less. Accordingly, the copper alloy material is excellent in strength and elongation and has a sufficiently small cross-sectional area, and various components using the copper alloy material can be reduced in size and weight.

The embodiments of the present invention have been described as above, but the present invention is not limited thereto, and can be appropriately changed without departing from the technical ideas of the present invention.

For example, the method of producing the copper alloy material is not limited to this embodiment, and the copper alloy material may be produced by another producing method. For example, a continuous casting device may be used in the melting and casting step.

### Examples

Hereinafter, results of confirmation experiments performed to confirm the effects of the present invention will be described.

A copper raw material formed of oxygen-free copper having a purity of 99.99 mass % or more was prepared, put into a carbon crucible, and melted in a vacuum melting furnace (degree of vacuum: 10⁻² Pa or less) to obtain molten copper. Mg and Cr were added to the obtained molten copper to adjust a component composition shown in Table 1, and after holding for 5 minutes, the molten copper alloy was poured into a cast iron mold to obtain a copper alloy ingot. Regarding the cross-sectional dimensions of the copper alloy ingot, the ingot was about 60 mm in width and about 100 mm in thickness. As a raw material of Mg as an additional element, a material having a purity of 99.9 mass % or more was used, and as a raw material of Cr, a material having a purity of 99.99 mass % or more was used.

Next, the obtained copper alloy ingot was cut into a predetermined size, and then subjected to hot working (hot rolling) under conditions shown in Table 1 to obtain a hot rolled material.

The hot worked material was subjected to first cold working (drawing) under conditions shown in Table 1, and a first cold worked material was obtained.

The first cold worked material was heated and held in an atmospheric furnace under conditions shown in Table 1, and then water-cooled and subjected to an aging treatment.

The obtained aging-treated material was subjected to second cold working (drawing) so as to obtain a cross-sectional area shown in Table 1, and a second cold worked material was obtained.

The second cold worked material was subjected to a tempering treatment under conditions shown in Table 1, and various copper alloy materials were obtained.

The component composition, workability, tensile strength, elongation, and electric conductivity of each copper alloy material obtained were evaluated.

### (Component Composition)

The component composition of the obtained copper alloy material was measured by ICP-MS analysis. As a result, a composition shown in Table 1 was confirmed.

### (Workability)

Those whose production was discontinued due to defects occurring during the manufacturing process were evaluated as “C”, those whose production was possible even in a case where defects occurred were evaluated as “B”, and those in which no defects were found were evaluated as “A”. The evaluation results are shown in Table 1.

### (Tensile Strength and Elongation)

After setting a gauge length to 250 mm, a tensile test was performed twice or more at a crosshead speed of 100 mm/min using AG-X 250 kN manufactured by Shimadzu Corporation, and the measured values were averaged. The evaluation results are shown in Table 1.

### (Electric Conductivity)

Using SIGMA TEST D2.068 (probe diameter: φ6 mm) manufactured by FOERSTER JAPAN Limited, a central part of the cross section of a sample of 10×15 mm was measured three times, and the measured values were averaged. The evaluation results are shown in Table 1.

TABLE 1

| | | | | | Manufacturing Process | | | | | |
|---|---|---|---|---|---|---|---|---|---|---|
| | | | | | | | | | | Second Cold |
| | | | | | | | First Cold | | | Working |
| | | | | | Hot Working | | Working | | | Cross- |
| | | | | | | Working | Working | Aging Treatment | | sectional |
| | | Composition (mass %) | | | Temperature | Rate | Rate | Temperature | Hour | area |
| | | Mg | Cr | Cu | (° C.) | (%) | (%) | (° C.) | (h) | (mm²) |
| Invention | 1 | 0.15 | 0.78 | Balance | 950 | 69 | 60 | 350 | 2 | 0.0005 |
| Examples | 2 | 0.50 | 0.38 | Balance | 910 | 71 | 80 | 450 | 4 | 0.01 |
| | 3 | 0.26 | 0.20 | Balance | 750 | 56 | 90 | 550 | 3 | 0.005 |
| | 4 | 0.43 | 0.90 | Balance | 880 | 88 | 85 | 400 | 1 | 0.1 |
| | 5 | 0.34 | 0.36 | Balance | 610 | 99 | 65 | 365 | 0.5 | 0.2 |
| Comparative | 1 | 0.08 | 0.65 | Balance | 950 | 75 | 75 | 600 | 8 | 0.06 |
| Examples | 2 | 0.60 | 0.41 | Balance | 800 | 61 | 60 | 330 | 3 | 0.001 |
| | 3 | 0.39 | 0.12 | Balance | 600 | 48 | 99 | 500 | 1 | 0.2 |
| | 4 | 0.31 | 1.50 | Balance | 700 | 81 | 10 | 450 | 4 | 0.0003 |

| | | Manufacturing Process | | | | | |
|---|---|---|---|---|---|---|---|
| | | Tempering | | Evaluation | | | |
| | | Treatment | | | Tensile | | Electric |
| | | Temperature | Hour | | Strength | Elongation | Conductivity |
| | | (° C.) | (h) | Workability | (MPa) | (%) | (% IACS) |
| Invention | 1 | 350 | 2 | A | 800 | 3 | 64 |
| Examples | 2 | 450 | 4 | A | 700 | 3 | 65 |
| | 3 | 550 | 3 | A | 640 | 4 | 68 |
| | 4 | 400 | 1 | A | 650 | 4 | 70 |
| | 5 | 365 | 0.5 | A | 620 | 3 | 67 |
| Comparative | 1 | 600 | 8 | B | 550 | 7 | 78 |
| Examples | 2 | 330 | 1 | B | 700 | 2 | 57 |
| | 3 | 540 | 1 | A | 510 | 5 | 67 |
| | 4 | — | — | C | — | — | — |

In Comparative Example 1 in which the Mg content was 0.08 mass %, which was less than the range of the present invention, the tensile strength was as low as 550 MPa. In addition, defects occurred during the manufacturing process, and the workability was not sufficient.

In Comparative Example 2 in which the Mg content was 0.60 mass %, which was more than the range of the present invention, the electric conductivity was as low as 57% IACS. In addition, the elongation was as low as 2%. Moreover, defects occurred during the manufacturing process, and the workability was not sufficient.

In Comparative Example 3 in which the Cr content was 0.12 mass %, which was less than the range of the present invention, the tensile strength was as low as 510 MPa.

In Comparative Example 4 in which the Cr content was 1.50 mass %, which was more than the range of the present invention, disconnection occurred during the working in which the cross-sectional area was reduced to 0.0003 mm² in the second cold working, and thus it was not possible to produce the copper alloy wire. Accordingly, the subsequent evaluation was stopped.

In contrast, in Invention Examples 1 to 5 containing, as a composition, Mg in a range of 0.15 mass % or more and 0.50 mass % or less, Cr in a range of 0.20 mass % or more and 0.90 mass % or less, and a balance consisting of Cu and inevitable impurities, in which tensile strength was 600 MPa or more, and an elongation was 3% or more, the workability was excellent, and the electric conductivity could also be secured.

From the above, it was confirmed that according to the invention examples, it is possible to provide a copper alloy material which is sufficiently excellent in strength and elongation and can be handled well even in a case where a cross-sectional area is reduced.

### INDUSTRIAL APPLICABILITY

According to the present invention, it is possible to provide a copper alloy material which is sufficiently excellent in strength and elongation and can be handled well even in a case where a cross-sectional area is reduced.

1. A copper alloy material having a composition comprising:
Mg in a range of 0.15 mass % or more and 0.50 mass % or less;
Cr in a range of 0.20 mass % or more and 0.90 mass % or less; and
a balance consisting of Cu and inevitable impurities,
wherein tensile strength is 600 MPa or more, and elongation is 3% or more.

2. The copper alloy material according to claim 1,
wherein electric conductivity is 60% IACS or more.

3. The copper alloy material according to claim 1,
wherein the copper alloy material is provided as a wire material, and a cross-sectional area perpendicular to a longitudinal direction is in a range of 0.0003 mm² or more and 0.2 mm² or less.
